(19) United States
(12) Patent Application Publication
(10) Pub. No.: US 2016/0125702 A1
(43) Pub. Date: May 5, 2016

(54) SYSTEM AND METHOD FOR PLAYING A CARD GAME

(71) Applicant: Casino Gaming LLC, Broadview, IL (US)

(72) Inventors: Frank Mugnolo, Broadview, IL (US); Kelley Drake, Chicago, IL (US)

(21) Appl. No.: 14/533,920

(22) Filed: Nov. 5, 2014

(51) Int. Cl. G07F 17/32; A63F 1/00

(52) U.S. Cl. CPC G07F 17/3293; A63F 1/00; G07F 17/3244; G07F 17/3262; A63F 2001/003

(57) ABSTRACT

After players make their wagers, a dealer deals hands comprised of two cards to each player and a hand comprised of two cards to the dealer. After the initial deal, the player will have the opportunity to split, double, hit, surrender or stand. When the player's ultimate hand (or hands) as dealt has a predetermined point value (of one of a plurality of predetermined point values), the player is offered an early payout option. If the early payout option is elected, the player receives a portion of the original wager. In one embodiment, the early payout option is offered only when the dealer's hand is not a natural. In another embodiment, an early payout option is offered only if the dealer's face up card is a predetermined value (or one of a plurality of predetermined point values), such as ten.

### FIELD

This disclosure is in the general field of casino gaming and, more particularly, relates to the game of Blackjack and an improved variation thereof.

### BACKGROUND

Blackjack is one of the most widely popular card games in casinos. There are many variations of the game played throughout the world. In general, the game utilizes a table with a semi-circular top that has a felt covering which carries images of player stations (typically a total of seven) spaced along the table top's arcuate edge. A dealer is usually seated adjacent to the straight edge of the table top (opposite the arcuate edge). The game can also be played on a computer or on a video gaming machine where the cards are computer-generated and displayed to the player on a terminal.

As many as seven players (or the total number of player stations) or as few as one player may play at the table adjacent to a player station. Accordingly, each player has an exclusive access to one of the stations. When the game is implemented on a computer, the game is typically played by one player against the computer, although internet-based Blackjack games may allow multiple players at the same virtual table.

The game is played with at least one standard deck of cards and may be played with multiple decks. Most casino Blackjack tables use six to eight standard decks of cards. Each card has a point value. An Ace has a point value of either one or eleven. Kings, Queens and Jacks have a point value of ten. All other cards have a point value equal to their nominal value. The cards are shuffled together and dealt by the dealer. Typically, when multiple decks are being used, the dealer deals from a shoe.

Each station includes an image marking an area for players to place bets (typically a circle). Before any cards are dealt, each player makes a wager by placing chips representative of the wager within the betting area at the player's station. Some casinos allow players to make wagers by placing cash within the betting area. Of course, in video or computer versions of Blackjack, there are many different ways for a player to place a bet. By way of example, a number representing the value of a wager amount may be displayed on a terminal screen or a video representation of chips that represent the wager may be displayed on an area of the screen. After the wagers are made, the dealer deals a first card to each of the players and to himself or herself. The dealer then deals a second card to each of the players and a second card to himself or herself whereby each of the players and the dealer have a hand consisting of two cards. Typically, each of the cards dealt to the players are dealt face up. At some tables, the player's cards are dealt face down. One of the cards dealt to the dealer is usually dealt face up (usually the first card) and the other card is usually dealt face down. The card that is dealt face down to the dealer (usually the second) is often referred to as the hole card.

Some casinos, mostly in Europe, give the dealer only one card face up until all the players have finished their hands. The dealer then deals his second card, and finishes his hand. This is sometimes called the European No Hole Card rule.

A point value of a hand is the sum of the point values of cards comprising the hand. The player's object is to acquire a hand whose point value is as close to twenty-one as possible, without exceeding twenty-one. When the point value of the player's hand exceeds twenty-one, the player loses his wager.

When the dealer's face up card has a point value of ten or is an Ace, the dealer typically looks at the hole card. When the sum of the point values of the dealer's first card and hole card is twenty-one (referred to as a “natural”), the dealer has “Blackjack.” Similarly, a player has “Blackjack” when he is dealt a natural.

If the dealer's face up card is an Ace, he will typically offer “Insurance” to the players before dealing the players any cards in addition to the initial two cards. Insurance bets can be made by betting up to half the player's original bet amount. An insurance bet is typically placed in an insurance betting stripe in front of the initial bet. This can be done in various ways in video or computer versions of Black Jack. The dealer will check to see if he has a 10-value card underneath his Ace, and if he does have Blackjack, the winning Insurance bet will be paid at odds of 2:1. The player loses his original bet of course (unless he also has a Blackjack), so the net effect is that the player breaks even (assuming the player bet the full half bet for insurance.) This is why the bet is described as “insurance”, since it seems to protect the player's original bet against a dealer Black Jack. Of course, if the dealer does not have Black Jack, the player loses the insurance bet, and still has to play the original bet out. In the simplest description, Insurance is a side-bet, where the player is offered 2:1 odds that the dealer has a 10-valued card underneath (“in the hole”) when the dealer is showing an Ace. When the dealer and the player both have naturals, there is no payout; the player retrieves the wager. This is often referred to as a “push.” When the dealer has a natural and the player does not have a natural, the dealer collects the wager. When the dealer does not have a natural and the player has a natural, the player usually receives a 3:2 payout on the wager.

When the dealer's hand is not a natural and a player's hand has a point value of less than twenty-one, the player may elect to have his hand augmented by one or more additional cards. When a player chooses to receive an additional card, this is commonly referred to as asking for a “hit.” A player can ask for a hit one or more times until the hand has a point value of greater than twenty-one. When a player does not want any further cards, this is commonly referred to as “standing.” Thereafter, a player who has a hand with a point value of twenty-one or less is referred to as a surviving player. If the point value of the hand is over twenty-one, the player loses his bet and is said to have “busted.” Other options that are also commonly available are splitting and doubling down. A player may split a hand when he is dealt a matching pair of cards. Electing to split results in the hand being split into two separate hands that are played independently. Doubling down can usually only be done with a two-card hand, before another card has been drawn. Doubling down allows the player to double his bet and receive one, and only one, additional card to the hand. Players are typically allowed to double down for “less” and place a bet of less than double the original bet.

Some casinos offer an option called “surrender.” This option can fall into two categories: early and late. Surrender offers the player the choice to fold his hand, at the cost of half of the original bet. The player must make that decision prior to taking any other action on the hand. For example, once the player draws a third card, splits or doubles down, surrender is no longer an option. The two varieties of surrender, early and late, differ only in the way a dealer Blackjack is handled. In an early surrender game, a player may choose to surrender before the dealer checks his cards for a Blackjack, offering a cheap way out even if the dealer turns out to have a Blackjack. A much more common variation is late surrender, where the dealer checks for Blackjack first, and then only if he does not have Blackjack will the dealer allow players to surrender their hands.

Another variation to the game of Blackjack is described in U.S. Pat. No. 5,988,644, entitled “Method of Playing a Card Game,” which names a common inventor to the present application. U.S. Pat. No. 5,988,644 is hereby incorporated by reference in its entirety. The assignee of the present application has marketed a variation to Blackjack that is based on the content of U.S. Pat. No. 5,988,644 under the name Guarantee 20®. This variation works as follows. The dealer deals both cards to himself or herself face down. If a player is initially dealt two cards with a point value of twenty, the player has the option of moving his original wager to a separate betting area to make the Guarantee 20® wager. The dealer then turns over one card. If the dealer's face up card is not an Ace or a ten, a player who made the Guarantee 20® wager is paid one half of his or her wager and his or her cards are removed. If the dealer's up card is an Ace or a ten, the dealer checks to see if he or she was dealt a natural. If the dealer was dealt a natural, a player who made the Guarantee 20® wager is paid 1.5:1 on his or her bet. If the dealer does not have a natural, those players who made the Guarantee 20® wager are paid one-half of their wager and those who did not are given a second chance to make the Guarantee 20® wager. If a player takes the second chance, he or she is immediately paid one half of his wager and his or her cards are removed. This modification to Blackjack requires a modification to the typical fashion in which cards are dealt because both of the dealer's cards are dealt face down as opposed to one face down and one face up.

After the players have made their elections (e.g., double down, split, surrender, hit one or more times and stand, or initially stand), the dealer exposes his or her hole card. When the dealer's hand has a point value of sixteen or less, the dealer must continue to augment his or her hand with additional cards until the point value of the dealer's hand is greater than sixteen. When the dealer's final hand has a point value greater than twenty-one, the dealer is said to have “busted” and makes a 1:1 payout on the wager of each of the surviving players.

The dealer may not augment his or her hand when it has a point value greater than sixteen. In other words, when the dealer's hand has a point value in a range of seventeen to twenty-one, it is the dealer's final hand. In some variations, a dealer must augment his or her hand when he or she has a “soft” seventeen—which occurs when the hand is comprised of an Ace and a six card.

Each of the surviving players wins a 1:1 payout on his or her wager when he or she has a hand with a point value greater than the point value of the final hand. Conversely, each of the surviving players loses his or her wager when he or she has a hand with a point value less than the point value of the final hand. A surviving player recovers his or her wager when he or she has a hand with a point value equal to the point value of the final hand (he or she is commonly said to have “pushed”).

Another variation to the game of Blackjack is described in U.S. Pat. No. 7,086,943 entitled “System and Method for Playing Blackjack,” which names a common inventor to the present application, and is hereby incorporated by reference in its entirety. The assignee of the present application has been marketing a variation to Blackjack that is based on the content of U.S. Pat. No. 7,086,943 under the name Automatic Win®. This variation works as follows. The dealer deals Blackjack according to the standard Blackjack rules. If the player is initially (in the first two cards) dealt a hand with a predetermined point value (e.g., in one embodiment, a total of twenty through either an Ace and nine, or two ten-value cards), the player is offered an early payout option in which the player receives a portion of the original wager as a win plus the return of the player's original wager and the game is ended immediately for the player after the player has elected to take the early payout option. In one embodiment, the early payout option is only offered if the dealer's face up card is a predetermined value (e.g., in one embodiment, a ten-value card) and when the dealer's hole card is not an Ace (i.e., the dealer does not have a natural). In one embodiment, the early payout option provides for a payout equal to half of the original wager plus the return of the original wager.

Casinos make money by offering Blackjack because the rules result in the casino receiving a slight advantage (sometimes lower than two percent) over the players. With a large volume of bets over time, the casino will reap large rewards. In light of this, it is advantageous to casinos to offer bets which attract players and which provide the casino with an edge—even if it is a very slight edge. It is also advantageous to casinos for the various bets to be simple from the perspective of the dealer so that the game can be dealt and played in an efficient and quick manner. Players, on the other hand, typically play the game for shorter periods of time than the house or casino (which is in theory always open). Accordingly, players may focus less on the statistical averages and more on “gut” feeling when making playing decisions. One frustrating aspect of play that a player must endure is having a hand comprised of two or more cards with a high point value (such as twenty) and then losing because the dealer draws a better hand (such as a twenty-one). It is therefore desirable to offer options that maintain or enhance the casino's edge in Blackjack while also providing more flexibility to the player and attracting more play.

### SUMMARY

The present disclosure relates to a method of playing a variation of the game of Blackjack where a player makes a wager against a house, the method comprising the steps of: dealing a player hand of two cards to a player after the player makes a wager; dealing a house card to the house wherein the house card is placed face up; dealing at least one additional card to the player hand; giving the player a payout option equal to a payout comprising a portion of the wager plus return of the wager if the player hand equals a value of twenty after the player hand receives the one or more additional cards and if the house card is a value of ten; and making the payout to the player if the player elects to accept the payout option.

The present disclosure further relates to a system for providing a variation to the game of Blackjack where a player makes a wager before cards are dealt by a house, comprising: a game manager that deals at least one card to a virtual dealer, a virtual hand of two cards to a player, and at least one additional card to the player and that monitors wagers, wherein the at least one card dealt to the dealer is placed face up before the player has the option to take any action associated with the virtual hand; an early payout processor that provides the player the option to elect to receive a payout of a portion of the wager when the virtual hand that was dealt to the player reaches a value of twenty after the player was dealt the at least one additional card and the face up card of the virtual dealer has a value of ten and that provides such a payout to the player and ends play of the virtual hand when the option has been elected.

### BRIEF DESCRIPTION OF THE DRAWINGS

Various examples of embodiments of the systems, devices, and methods according to this invention will be described in detail, with reference to the following figures, wherein:

FIG. 1 is a plan view of a covering of the top of a Blackjack table, according to various examples of embodiments.

FIG. 2 is a flow chart illustrating the steps of the game, according to various examples of embodiments.

FIG. 3 is an example architecture of the game implemented electronically, according to various examples of embodiments.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

The present disclosure relates to a modification to the traditional game of Blackjack. It also relates to improvements to the modifications to the game of Blackjack which is described in U.S. Pat No. 7,086,943. The present disclosure can enhance the experience of the player and contribute to the profitability of the house or casino. The term “house” is used herein to mean whatever entity the player is playing against, such as the casino. The modifications can be simple and can be accomplished without a significant impact upon the speed of the game. The following description is presented to enable a person of ordinary skill in the art to make and use the invention, and is provided in the context of a particular application and its requirements. Various modifications to the preferred embodiment will be readily apparent to those skilled in the art, and the generic principles defined herein may be applied to other embodiments and applications without departing from the spirit and scope of the invention. Thus, the present invention is not intended to be limited to the embodiments shown and discussed, but is to be accorded the widest scope consistent with the principles and features disclosed herein.

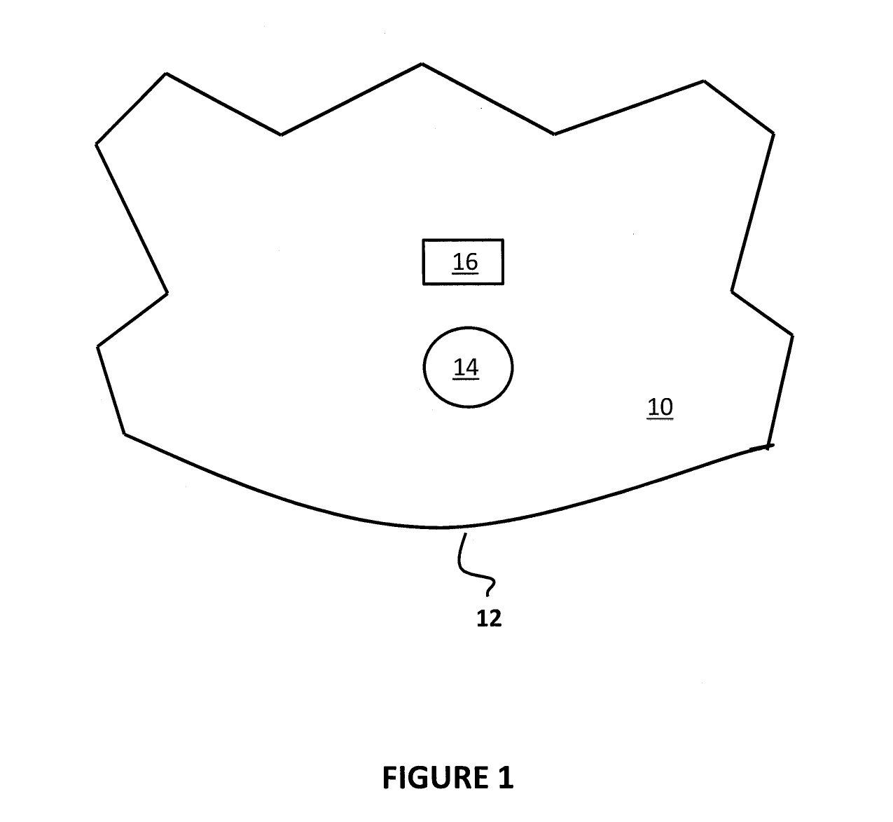

Referring now to FIG. 1, an image of an example player station on a typical Blackjack table is shown. In various embodiments, a player station 10 is one of a plurality of images of player stations printed on a felt covering of the top a semicircular Blackjack table. More particularly, the stations are preferably evenly spaced adjacent to an arcuate edge 12 of the table. A player (not shown) may be seated adjacent to the station 10. Other players may be similarly seated adjacent to respective player stations. A dealer (not shown) may stand or otherwise be stationed adjacent to a straight edge (not shown) of the table. In various embodiments, the image includes a circle 14 wherein chips or cash representative of a wager may be placed by the player before the cards are dealt.

It should be appreciated, however, that the disclosure is not limited to any particular configuration of a gaming table.

In addition, although FIG. 1 depicts and the following description focuses on a typical physical Blackjack table where players sit, the invention is not so limited. For example, the game can be implemented “virtually” on a computing device, such as a video gaming terminal or on a personal computer where the computer deals the cards and where the cards are represented by images displayed on a video terminal. The game can be running on a dedicated computing device located, for example, on the floor of a casino or can be offered on a server which can be accessed by players through the internet (e.g., internet-based casinos).

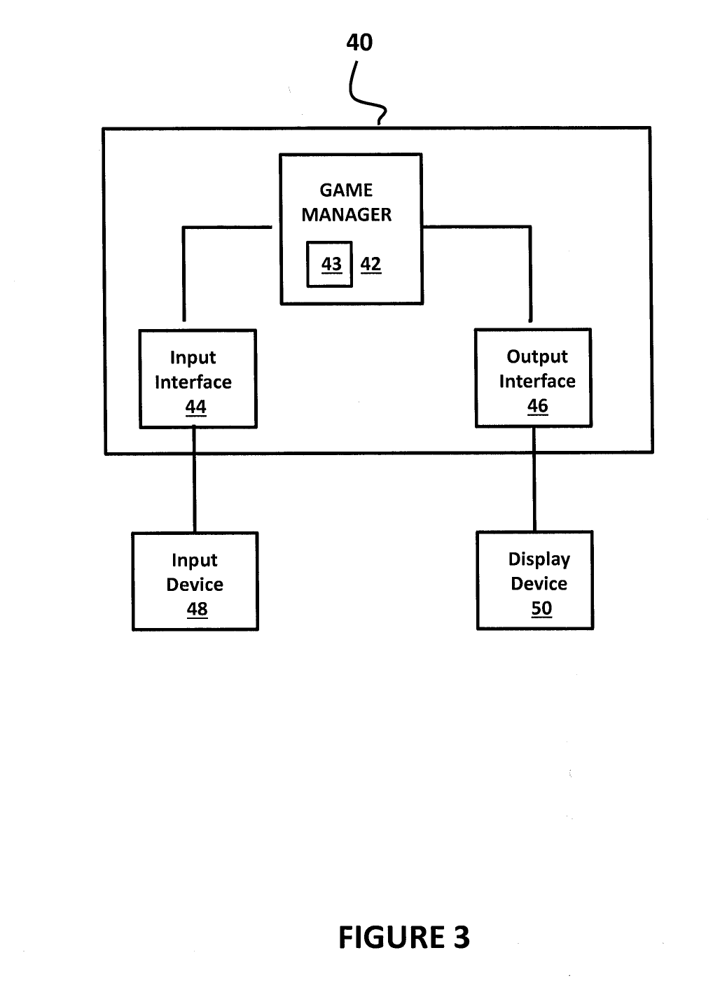

An example of such an arrangement is illustrated in FIG. 3. As shown in FIG. 3, the modification to Blackjack in its various embodiments described herein may be implemented on a computing device 40. Computing device 40 may be any computing device such as a personal computer, a dedicated video game (e.g., on the floor of a casino), a handheld computing device, a server or computer connected to the internet or a network (by any method of connecting two or more computing devices), etc. Such computing devices generally include a central processing unit (CPU) (not shown) such as a microprocessor, a microcontroller, or any device that performs arithmetic, logic or control operations, and a storage device (not shown) such as a magnetic disk, an optical disk, or any other volatile (e.g., Random Access memory (“RAM”)) or non-volatile firmware (e.g., Read Only Memory (“ROM”)) storage system readable by the central processing unit. In various embodiments, computing device 40 includes a game manager 42. In various embodiments, game manager 42 includes logic that manages a Blackjack game. For example, game manager 42 may be programmed to establish the virtual or electronic deck of cards to be dealt and deals the cards (which comprise data stored in the computing device and may be represented by graphics or text displayed to a player). Game manager 42 may also manage a game by accepting input from players (such as wagers, decisions to hit, stand, etc.), by determining winners and losers, and/or providing instructions relating to payouts. In various embodiments, game manager 42 interfaces with an input device 48 (e.g., via an input interface 44). The invention is not limited to any particular type of input device and may include a keyboard, a mouse, physical buttons on a video gaming device, virtual buttons generated on the display of a video gaming device, etc. Game manager 42 may also interface with a display device 50 via a display interface 46. The invention is not limited to any particular type of display device and may include, among other things, any type of monitor. In various embodiments, game manager 42 includes an early payout processor or logic 43 that implements the modification (in its various forms) to Blackjack described herein. Early payout processor or logic 43 may be a separate module or it may be integrated into game manager 42. Input device 48 and display device 50 may be directly connected to computing device 40 and/or may be connected via a network connection (such as the internet). Also, although the various blocks or components shown in FIG. 3 are shown separately, various portions of those blocks or components may be combined or separated into further blocks or components. For example, game manager 42 may be distributed across multiple computing devices. In addition, game manager 42 may be implemented in software or hardware.

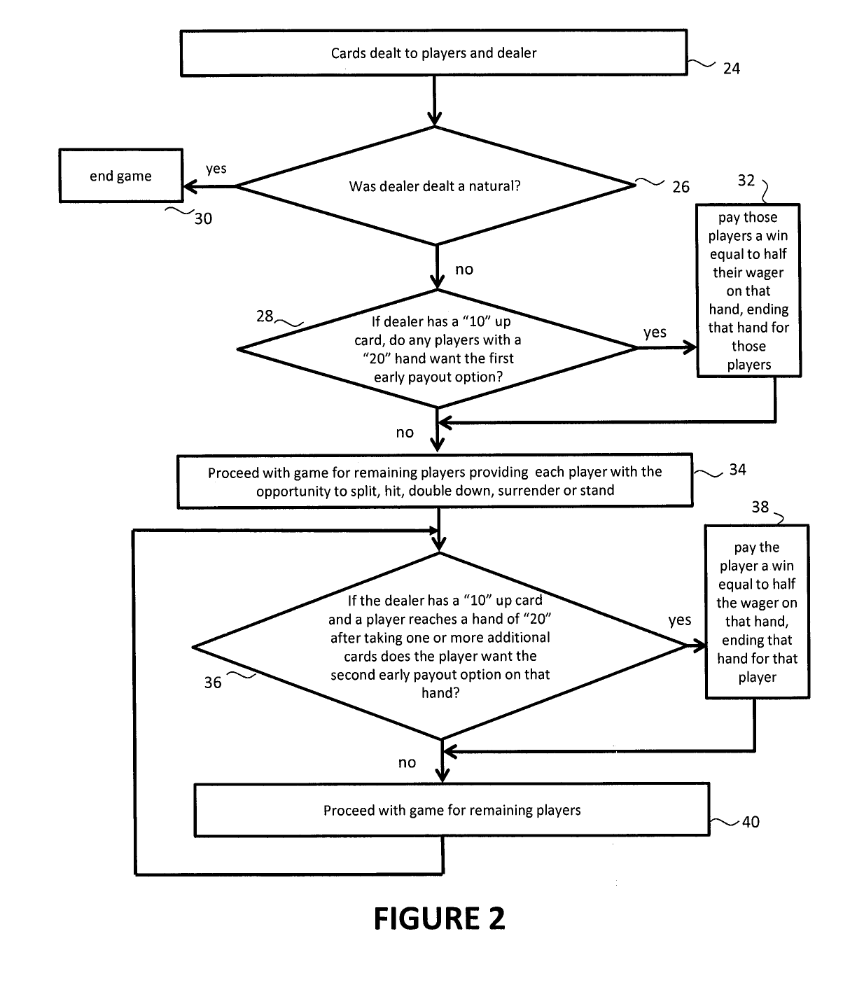

Referring now to FIG. 2, an example of one embodiment of a modification to a game of Blackjack (e.g., traditional Blackjack) is shown. It should be understood that more or fewer steps may be utilized or the steps may occur in one or more orders that are different from the order of steps illustrated in FIG. 2 without departing from the spirit of the invention. For example, rather than examining whether the dealer was dealt a natural before offering certain players the option of forcing the casino to surrender (as shown at Step 26 of FIG. 2), the game may provide that such a step be performed after the step shown at Step 28. As another example, the modification to Blackjack may only include the portion of the flow chart of FIG. 2 that begins at Step 36. There are many other examples, too numerous to mention here.

In various embodiments, after wagers are placed, a dealer deals hands to the players and himself or herself as shown at Step 24. Each player hand is comprised of two cards. The dealer's hand also typically is comprised of two cards (but, could initially be just one card as is the case in games following the European No Hole card rule). The cards may be dealt from a shoe (or in the case of a video or computer version, from a virtual shoe), which typically contains six to eight standard decks of cards that are shuffled together. The cards may alternatively be dealt from the dealer's hands. When this is done, the dealer typically shuffles a smaller number of decks together, such as one or two decks. In various embodiments, one of the dealer's cards is dealt facing down (the hole card) and the other card is dealt facing up (the up card). In another embodiment, both of the dealer's cards are dealt face down and one is flipped over before play continues.

Next, the process moves to Step 26, where a determination is made whether the dealer was dealt a natural. In Step 26, if the dealer's up card has a value of ten or is an Ace, in various embodiments, the dealer examines the hole card to see if he or she was dealt a natural Blackjack. If the dealer's up card is an Ace, the dealer also typically offers Insurance to the players. If the dealer was dealt a natural, the process moves to Step 30, and in various embodiments, the game is finished. In various embodiments, the dealer collects all of the players' wagers except for any players who were also dealt a natural. Any player who was dealt a natural may keep his or her original bet and is typically said to have “pushed.”

If the dealer was not dealt a natural, the process moves to Step 28 where, in various embodiments, any player who was dealt a hand with a predetermined point value is given the opportunity to elect to receive a predetermined payout and end the game for that player. In effect, in various examples of embodiments, the player is forcing the casino to surrender by folding its hand with respect to that player. In various embodiments, the predetermined point value is twenty and the process moves to Step 32, where one or more players are paid and a predetermined payout is a win equal to one half of a player's wager plus the return of the wager. Hereinafter, this election may be referred to as the first early payout option. The first early payout option may be offered to a player before the player takes any other action associated with his or her hand. The first early payout option may be offered or made available to all players only before any player takes any other action (e.g., in the same way Insurance is typically offered). Or, the first early payout option may be offered or made available to each player when it is his/her turn to take an action with the dealt hand. This does not preclude, however, a player taking an action associated with the dealer's hand (such as an Insurance bet when the dealer's face up card is an Ace) before electing the first early payout option. In an example embodiment, the first early payout option (shown at Step 28) is not available unless the dealer has an up card with a predetermined value (e.g., ten). The first early payout option is further described in U.S. Pat. No. 7,086,943.

From Steps 28 or 32, the process moves to Step 34. In Step 34, in various embodiments, the game proceeds for all remaining players, and each player is presented with an opportunity to take further actions associated with the hand (depending on the cards that they hold and the Blackjack rules applicable to that particular game) to split, double down, hit, stand or surrender. In various embodiments, the process moves to Step 36 where, if a player's hand reaches a predetermined point value (e.g., twenty) after taking one or more additional cards, the player is given an opportunity to elect to receive a predetermined payout, (e.g., half of the player's wager plus the return of the wager on that hand). In various embodiments, if the player accepts the opportunity, the process moves to Step 38 and the player receives that payout which ends that player's hand. Step 36 may be hereinafter referred to as the second early payout option. Either the first early payout option (Step 28) or the second early payout option (Step 36) may hereinafter be referred to as an early payout option. From Steps 36 or 38, the process moves to Step 40 where, in various embodiments, the game proceeds for all remaining players according to standard Blackjack rules and with each player being provided the second early payout option. Performance of all of the steps shown in FIG. 2 is not required. For example, it is possible to offer only the second payout option and not offer the first payout option.

The invention is not limited to any particular manner in which the dealer presents an offer of an early payout to the player or in how a player indicates a desire to take an early payout option. For example, if the game is being played on a computing device, the player could indicate a desire to take the option by pressing a button (either physical or on the video screen or touch screen). In addition, while this embodiment provides the player with an early payout option if he or she was dealt a hand with a point value of twenty, the disclosure is not so limited. An early payout option may be offered to players based on any predetermined point value or values. In an alternative embodiment, Step 26 need not be performed prior to Step 28 and a player with a hand of a predetermined point value may be given the first early payout option even before the dealer checks to see if he or she was dealt a natural. In games following the European No Hole card rule, this alternative may be necessary. The dealer or computing device may formally present an offer to the player for a response, or alternatively, the player may have to request the early payout option without formal prompting from the dealer or computing device.

In an example embodiment, an early payout option (shown at Steps 28 and 36) is not provided unless the dealer has an up card with a value of ten. However, the present invention is not limited to providing the early payout option only when the dealer has a particular up card.

As shown at Steps 32 and 38, for a player who elects an early payout option, that player is paid a win equal to a portion of the amount of his or her wager (e.g., half) plus the return of that player's wager on that hand, and that hand is ended for that player (and that hand is collected). The player may be paid the portion of the wager at the time the player elects to accept the early payout option or after the game is finished for all players at the table. Referring back to FIG. 1, in an example embodiment, when a player elects an early payout option, the dealer may place the winning amount of the wager (e.g., half the wager) in space or box 16 adjacent to betting circle or space 14. Putting the early payout winnings in a separate box helps provide clear confirmation of the election of the early payout option to casino supervisors and to casino surveillance. The disclosure is not limited, however, to any particular approach or technique for how the winning wager is paid out. For example, the winning wager may simply be put next to the original wager without any need to modify the images on a standard Blackjack table. Some further examples include paying out the winning wager immediately or crediting it for later payout (e.g., if the game is implemented on a video gaming machine) or crediting the winning wager to an account (e.g., if the game is implemented on an internet gaming device).

Using an eight-deck shoe following the standard Las Vegas Blackjack rules, the variation or modification to Blackjack incorporating both the first and second payout options has been projected to result in an overall house advantage of approximately 5.80% when an early payout option is elected by the player. This projection assumes that an early payout is a win equal to half of the player's wager plus the return of the player's wager. Using six-deck, two-deck and one-deck configurations and following the standard Las Vegas Blackjack rules, the overall house advantages have been projected to be approximately 5.85%, 6.41%, and 7.20%, respectively.

These projections were based on a probabilistic analysis of the expected distribution of the outcomes of the dealer's final hands and the difference in the expected value of a player taking an early payout option as compared to declining the early payout option and playing out the hand to its conclusion. The dealer's probability of reaching various totals (resulting in a dealer win, push or loss) was determined by hitting the dealer's hand from the remaining shoe until the dealer either had a seventeen or above or until the dealer busted. These probabilities take into account the impact on the remaining deck of those cards that are already known. This analysis for eight, six, two and one-deck shoe configurations for the various embodiments generated the following results shown in Table 1 below:

TABLE 1
Preferred Embodiment Incorporating First and
Second Early Payout Options

| | Player's Hand Equals a Point Value of 20 | | | |
|---|---|---|---|---|
| | 8 Deck | 6 Deck | 2 Deck | 1 Deck |
| | Shoe | Shoe | Shoe | Shoe |
| | (Percentage) | | | |
| Player Win | | | | |
| Dealer 17 | 12.15 | 12.17 | 12.39 | 12.68 |
| Dealer 18 | 12.14 | 12.15 | 12.31 | 12.54 |
| Dealer 19 | 12.16 | 12.17 | 12.37 | 12.67 |
| Dealer Bust | 23.03 | 23.04 | 23.14 | 23.28 |
| Total | 59.47 | 59.53 | 60.21 | 61.18 |
| Player Push | | | | |
| Dealer 20 | 36.75 | 36.67 | 35.88 | 34.73 |
| Player Loss | | | | |
| Dealer 21 | 3.78 | 3.80 | 3.91 | 4.09 |
| Player's Expectation | 56.90 | 56.95 | 57.48 | 58.33 |
| House Advantage | 5.80 | 5.85 | 6.41 | 7.20 |
| Total Occurrence Frequency | 4.86 | 4.85 | 5.03 | 4.85 |

In the embodiment illustrated in Table 1, in an eight-deck shoe configuration, the circumstances under which the first or second early payout option will arise will occur on 4.86% of all hands. When this happens, on a weighted average basis, the dealer will end up, i) with a hand totaling seventeen, eighteen, nineteen or bust 59.47% of the time (in which case the player would have received a win equal to his or her entire wager), ii) with a hand totaling twenty 36.75% of the time (in which case the player would have pushed) and, iii) with a hand totaling twenty-one 3.78% of time (in which case the player would have lost his or her entire wager).

The house advantage resulting from the player electing to accept an early payout option will equal approximately 5.80%. Thus, there is described herein variations of Blackjack where a player has potential options of being guaranteed a payout when a hand formed by the cards dealt to the player and dealer have a predetermined point value. This variation is simple to implement and should not appreciably affect the speed of the game. Various embodiments described herein are projected to result in an edge to the house/casino. It should be noted, however, that the present disclosure is not limited to situations where the variation results in an edge to the house. The statistics described above only illustrate the probabilities associated with a particular embodiment of the game—where the early payout option is for a win equal to half of the wager plus the return of the player's wager and is limited to a player hand totaling twenty and where the option is given only after the dealer checks for Blackjack and only when the dealer has an up card of ten. The probabilities would differ, of course, if other embodiments of the game were implemented. It should be noted that the embodiments described in the present invention produce a higher occurrence frequency and higher weighted average house advantage as compared to the embodiments of the variation described in U.S. Pat. No. 7,086,943.

It should be understood that the above description of embodiments and specific examples are given by way of illustration and not limitation. For example, the features described herein could be incorporated into any variation of the game of Blackjack. Many changes and modifications within the scope of the present embodiments may be made without departing from the spirit thereof, and the present invention includes all such changes and modifications.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied (e.g., by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

We claim:

1. A method of playing a variation of the game of Blackjack where a player makes a wager against a house, the method comprising the steps of:
dealing a player hand of two cards to a player after the player makes a wager;
dealing a house card to the house wherein the house card is placed face up;
dealing at least one additional card to the player hand;
giving the player a payout option equal to a payout comprising a portion of the wager plus return of the wager if the player hand equals a value of twenty after the player hand receives the one or more additional cards and if the house card is a value of ten; and
making the payout to the player if the player elects to accept the payout option.

2. The method of claim 1, wherein the portion of the wager is one half of the wager.

3. The method of claim 1, further comprising the step of collecting the player's cards after the payout is made.

4. The method of claim 1, further comprising the step of dealing a hole card to the house to make a house hand.

5. The method of claim 4, wherein the house card is dealt face up and the hole card is dealt face down.

6. The method of claim 5, further comprising the step of examining the hole card if the house card has a value or ten or is an Ace to determine if the house hand is a natural Blackjack.

7. The method of claim 6, wherein the step of giving the player the payout option is only given to the player if the house hand is not a natural Blackjack.

8. The method of claim 1, wherein the player makes the wager by placing the wager in a first area and wherein the step of paying the payout further comprises placing the payout in a second area.

9. The method of claim 1 wherein the steps are performed by program instructions stored on a computer-readable medium and wherein the cards are represented graphically on a visual display.

10. A system for providing a variation to the game of Blackjack where a player makes a wager before cards are dealt by a house, comprising:
a game manager that generates at least one card to a virtual dealer, a virtual hand of two cards to a player and at least one additional card to the virtual hand of the player, and that monitors a wager of the player, wherein the at least one card generated to the dealer is generated face up before the player has the option to take any action associated with the virtual hand;
an early payout processor that provides the player the option to elect to receive a payout of a portion of the wager of the player plus return of the wager of the player, when the virtual hand dealt to the player reaches a value of twenty after the at least one additional card is generated to the player, and when the face up card of the virtual dealer has a value of ten, and that provides such a payout to the player and ends play of the virtual hand when the option has been elected.

11. The system of claim 10 further comprising:
a display device for displaying the generated cards to the payer; and
an input device that allows the player to input playing decisions.
